(19) United States
(12) Patent Application Publication
(10) Pub. No.: US 2007/0265855 A1
(43) Pub. Date: Nov. 15, 2007

(54) mCARD USED FOR SHARING MEDIA-RELATED INFORMATION

(75) Inventors: Michiel Maandag, Sipoo (FI); Heikki Norta, Espoo (FI); Floris van de Klashorst, Rye, NY (US); Juha P. Kokkonen, Oulu (FI); Juha-Pekka Sipponen, Espoo (FI); Jonas Geust, Jorvas (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/382,290

(22) Filed: May 9, 2006

(51) Int. Cl. G06Q 10/00; G06Q 30/00

(52) U.S. Cl. 705/1

(57) ABSTRACT

A media card, or mCard, is provided for sharing information relating to one or more media objects (e.g., audio, video or image files, etc.) between media terminals. In particular, mCards, or data packets including both origin-controlled data (e.g., song, movie or TV show title, artist or album name, images of the album/DVD cover, etc.) and personalized data (e.g., personal comments, ratings, etc.) associated with a corresponding one or more media object, are capable of being transmitted using any number of messaging applications (e.g., SMS, MMS, IM, e-mail, or the like) and of subsequently being accessed, edited, deleted, and the like, using any number of media rendering applications (e.g., music players, video players, gaming applications, etc.).

### FIELD

Exemplary embodiments of the present invention relate, generally, to media objects and, in particular, to a technique for sharing information relating to those media objects.

### BACKGROUND

With the usage of advanced features in the latest personal devices (e.g., cellular telephones, personal digital assistants (PDAs) pagers, and the like) the creation and consumption of media objects or files has become part of many individuals' everyday life. This includes taking digital photos, downloading and listening to digital music, watching short videos, and more. Apart from self-creation and self-consumption, the concept of content sharing has become stronger than ever. People want to be able to share their content on many different levels with others including, for example, their family, friends and colleagues. In addition, various service providers including, for example, online retail sources of music and/or video files, want to be able to advertise and provide these media objects to their customers in a user-friendly manner.

Typically, however, little if anything can be discovered about a media object without actually accessing the media object and, where possible, reviewing the metadata (i.e., data about data) that is associated with the particular media object. To illustrate, an individual may desire to know the name of the singer or artists of a particular song, or the album on which the song can be found. Similarly, the individual may like to know who the actors are in a movie or TV show associated with a particular video clip. In some instances, the media object may be linked to metadata that includes some of this information. However, the information conveyed by the metadata is limited and often cannot be easily interpreted. In addition, the metadata is directly linked to the media object itself. In other words, an individual is not able to access the metadata unless he or she already possesses the media object. The individual is further not able to share the metadata with others without also sharing the media object.

In many instances it would be desirable to be able to share information related to various media objects without being required to also transmit or share the media object itself. For example, a recommendation service (i.e., a service that provides, for example, music recommendations based on past purchases of a particular individual or information provided by the individual regarding his or her likes and dislikes) may desire to distribute information relating to various song of music file recommendations to its subscribers without actually providing the music file itself. The information may include comments, a rating of the song, a picture of the artist or album, a link to where the song can be purchased, or the like.

In many instances it may also be desirable for an individual to be able to easily view and access information relating to media objects he or she already owns and has stored on his or her media terminal (e.g., mobile terminal, such as a cellular telephone, PDA, laptop, pager, and the like, music player, gaming device, etc.).

A need exists for a simple, and legal, technique for enabling consumers to share media-related information. In addition, a need exists for a rich, but simple, technique for service providers to promote, communicate and exchange such information. Finally, it is desired to set a standard for viewing and exchanging media-related information within the mobile industry.

### BRIEF SUMMARY

In general, exemplary embodiments of the present invention provide an improvement over the known prior art by, among other things, providing a media card, or mCard, that is capable of being used to communicate information relating to one or more media objects (e.g., audio, video, music or graphic files) to various devices.

According to one aspect, a media terminal is provided that is capable of receiving media-related information. In one exemplary embodiment, the media terminal includes: (1) one or more media rendering applications configured to render one or more media objects and to display metadata associated with respective media objects rendered; and (2) a messaging application configured to receive a message comprising information relating to one or more media objects, to determine a type associated with the media objects, and to associate the message with one of the media rendering applications based at least in part on the type determined. According to this exemplary embodiment, the media rendering application with which the message is associated is further configured to store at least part of the information of the message as metadata of the one or more media objects with which the information relates.

According to another aspect, a method is provided for sharing media-related information. In one exemplary embodiment, the method includes: (1) receiving a message comprising information relating to one or more media objects; (2) determining a type associated with the one or more media objects; (3) associating the message with a media rendering application based at least in part on the type determined, such that the information of the message is capable of being accessed using the media rendering application with which the message is associated; and (4) storing at least part of the information of the message as metadata of the one or more media objects with which the information relates.

According to yet another aspect, a computer program product is provided that includes a computer-readable storage medium having computer-readable program code portions stored therein. In one exemplary embodiment the computer-readable program code portions are configured to perform the steps of the above-referenced method for sharing media-related information.

According to one aspect, an apparatus is provided that is configured to receive media-related information. In one exemplary embodiment, the apparatus includes: (1) a means for receiving a message comprising information relating to one or more media objects; (2) a means for determining a type associated with the one or more media objects; (3) a means for associating the message with a media rendering application based at least in part on the type determined, such that the information of the message is capable of being accessed using the media rendering application with which the message is associated; and (4) a means for storing at least part of the information of the message as metadata of the one or more media objects with which the information relates.

According to another aspect, a media service provider is provided. In one exemplary embodiment, the media service provider includes: (1) a means for creating one or more media messages comprising information relating to one or more media objects: (2) a means for receiving a request for provisioning of a media service; (3) a means for transmitting the one or more media messages in response to receiving the request; (4) a means for receiving a purchase request for at least one of the one or more media objects; and (5) a means for communicating the purchase request to a source from which the media objects can be purchased.

According to yet another aspect, a method of providing a media service is provided. In one exemplary embodiment, the method includes: (1) creating one or more media messages comprising information relating to one or more media objects: (2) receiving a request for provisioning of a media service; (3) transmitting the one or more media messages in response to receiving the request; (4) receiving a purchase request for at least one of the one or more media objects; and (5) communicating the purchase request to a source from which the media objects can be purchased.

According to another aspect, a computer program product is provided that includes a computer-readable storage medium having computer-readable program code portions stored therein. In one exemplary embodiment, the computer-readable program code portions are configured to perform the steps of the above-referenced method of providing a media service.

According to yet another aspect, an apparatus is provided that is configured to provide a media service and includes a processor and a memory, which is in communication with the processor and stores an application executable by the processor. In one exemplary embodiment, the application is configured, upon execution, to: (1) create one or more media messages comprising information relating to one or more media objects: (2) receive a request for provisioning of a media service; (3) transmit the one or more media messages in response to receiving the request; (4) receive a purchase request for at least one of the one or more media objects; and (5) communicate the purchase request to a source from which the media objects can be purchased.

According to another aspect, a data packet is provided for transferring media-related information between one or more devices. In one exemplary embodiment, the data packet includes: (1) a first type of data including origin-controlled metadata associated with one or more media objects: (2) a second type of data comprising personalized metadata associated with the one or more media objects; (3) a message type metadata; and (4) a user identification metadata.

According to a final aspect, a system is provided for sharing media-related information. In one exemplary embodiment, the system includes: (1) a device associated with a media service provider that is configured to create one or more media messages including information relating to a respective one or more media objects and to transmit the media messages; and (2) a media terminal in communication with the device that is configured to receive at least one of the one or more media messages, to determine a type associated with the one or more media objects of the media message received, and to associate the media message with a media rendering application stored on the media terminal based at least in part on the type determined. According to this exemplary embodiment, the media rendering application with which the message is associated is configured to store at least part of the information as metadata of the one or more media objects, such that the information of the message is capable of being subsequently accessed using the media rendering application.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 illustrates an example of an mCard that may be created and shared in accordance with exemplary embodiments of the present invention;

FIG. 2 illustrates manners in which media objects and/or mCards may be transmitted to a mobile terminal in accordance with exemplary embodiments of the present invention;

FIG. 3 is a flow chart illustrating the steps which may be taken in order to share media-related information in accordance with exemplary embodiments of the present invention;

FIG. 4 is a block diagram of one type of system that would benefit from exemplary embodiments of the present invention;

FIG. 5 is a schematic block diagram of an entity capable of operating as a device associated with a Media Service Provider in accordance with exemplary embodiments of the present invention; and

FIG. 6 is a schematic block diagram of a media terminal capable of operating in accordance with an exemplary embodiment of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide an improvement over the prior art by, among other things, providing a media card (i.e., a file with metadata), also referred to as a media message or mCard, that is capable of being used to share media-related information using media terminals (e.g., mobile terminals, such as cellular telephones, mobile communications devices, personal digital assistants (PDAs), laptops, pagers, and the like, mobile or fixed music, video or image players, gaming devices, TV receivers, FM/AM digital radio receivers, digital cameras/camcorders, GPS devices, etc., or any combination of the aforementioned devices). In particular, mCards permit the transfer of information associated with respective media objects between systems, even if the media object itself is protected by a Digital Rights Management (DRM) system (i.e., a system that authorizes the viewing or playback of copyrighted material on a user's computer or digital music player).

According to exemplary embodiments, an mCard is a data packet containing information relating to one or more media objects, which may include, for example, analog or digital audio, video, image files or formats (such as CD, DVD, MP3, WMA, WAV, AAC, DAT, SACD, M4A, JPEG, GIF, TIFF, SVG, MPEG, etc.), text files, graphic presentations, web pages, software applications (e.g., game applications, JAVA applets, or Binary Runtime Environment for Wireless (BREW) applications), or the like. A single mCard may correspond with, for example, a single song, an entire music album, a group of songs belonging to a particular genre, a movie, a television show, or the like.

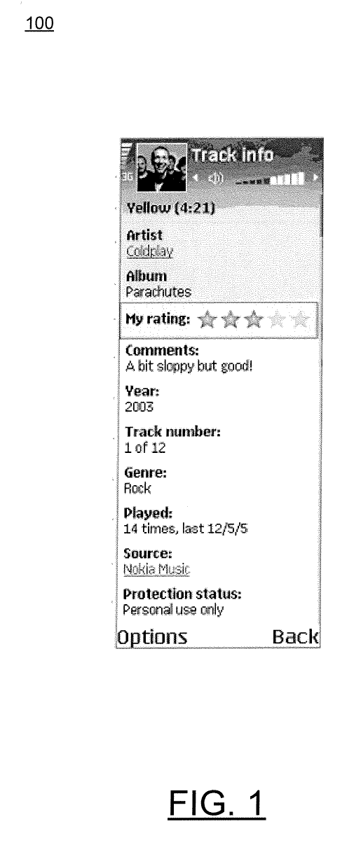

In one exemplary embodiment, the mCard may comprise the digital representation of the metadata stored in the one or more media objects (i.e., the media object details). As shown in FIG. 1, which illustrates an example of an mCard 100 that may be created and shared in accordance with exemplary embodiments of the present invention, information stored in the mCard 100 may include, for example, origin-controlled data (i.e., data that is not capable of being subsequently added to or changed), such as information relating to the corresponding media object (e.g., song, movie or TV show title, artist name, list of actors, genre, originator data, etc.), available art corresponding with that media object (e.g., images, pictures, video and/or audio files of the artist or album/DVD), location information for where the media object can be purchased (e.g., a link to a particular web site and/or the physical location of a store from which the media can be purchased, retailer data), delivery data (i.e., information on parties that have received/sent the mCard) and/or .DRM data. Personalized data may also be capable of being added to the mCard 100 and subsequently edited. The personalized data may include, for example, personal comments, ratings, figures, images, e-mail, Short Message Service (SMS)/Multimedia Messaging Service (MMS) messages, games, a blog address, podcasting delivery/receiving information, and the like, relating to the corresponding media object(s).

The mCard 100 may comprise a text file including only simple details related to the corresponding media object. Alternatively, or in addition, the mCard 100 may include multimedia content, such as a video or audio clip (e.g., a portion of a song or movie), or the like, created by a user.

Once created, the mCard 100 may be attached to the corresponding one or more media objects by comparing metadata between the mCard and the one or more media objects. In addition, the mCard is capable of being separately stored and shared or distributed freely. For example, as is discussed in more detail below, mCards 100 are capable of being exchanged from person-to-person, downloaded from a particular web site, or transmitted to one or more consumers in fulfillment of a subscription or as part of a promotion. In particular, in one exemplary embodiment, the mCard 100 is capable of being communicated via a messaging application, such SMS, MMS, Instant Messaging (IM) or e-mail, or via IP broadcasting/multicasting/point-to-point casting, or the like. Upon receipt, the mCards 100 are capable of being viewed, shared, stored in various folders and/or deleted.

Exemplary Use Cases:

The following provides a few examples of how exemplary embodiments of the present invention may be used to share media-related information with various individuals and parties. In the first exemplary use case, a user/owner of one or more media objects may create one or more mCards from the one or more media objects. These mCards are then exchanged from person-to-person in order for an individual to share the media-related information he or she has gathered with, for example, his or her friends, family members, colleagues, and the like. In this case, the mCards may contain information describing a particular media object including, for example, information relating to a particular song, an image or art associated with the song (e.g., the album cover), and/or where the song can be purchased, as well as a party's personal comments regarding the media object. The recipient of the mCard may merge the received mCard with the metadata already existing on his or her media terminal related to the particular media object (assuming the media object is already stored on the recipient's media terminal).

Alternatively, consumers may download mCards to their media terminals, for example, from an Internet site associated with an online retail shop. In particular, a consumer may preview a particular media object online, for example by accessing a web site associated with a party from whom the media object may be purchased (e.g., an online retail shop), and, in the process, download an mCard associated with the media object. Where, for example, the media object is a song or audio file, the mCard may include song details (e.g., song title, artist, genre, etc.), a small audio clip, and a link to where the song can be purchased and downloaded to the media terminal. Music review sites and/or artist sites may also provide mCards with song information, video samples of concerts or gigs, and/or where the song can be purchased.

As another example of how exemplary embodiments of the present invention may be used, the music, movie and/or television industry may use mCards to inform consumers regarding new songs, albums, movies and/or television series. These industries may, for example, either mass distribute the mCards like advertisements or distribute the mCards to specific individuals as part of a subscription to a particular service. Alternatively, or in addition, the industries may make the mCards available for downloading from their respective web sites. The mCard may contain, for example, a clip from a song, movie or television show along with detailed information about the song, album, artist, movie, television show and/or actors playing in the movie or television show. In addition, the mCard may include where the media object can be purchased (e.g., a particular web site from which the media object can be downloaded, or the physical location of a particular store where an album or DVD may be purchased) or viewed (e.g., the dates and local theaters where the movie will be playing, or the date, time and television station on which the television show will air).

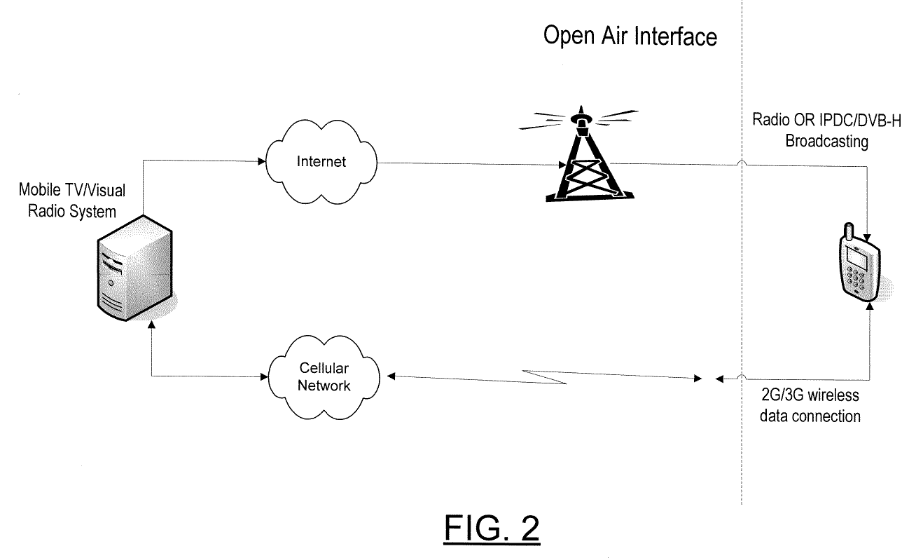

In yet another exemplary use case, the music industry and, in particular radio stations, may use mCards in order to provide information regarding the song that is currently playing on the radio station. For example, a caller may use his or her media terminal to send an SMS message to a particular radio station (e.g., STAR 98.9 FM) inquiring into the song that is currently playing. In response, the radio station may transmit an mCard with information about the song that can be downloaded to the recipient's media terminal. Similarly, in a Visual Radio system, the user may receive the media content/objects (i.e., the audio file) from the music service provider, radio station and/or broadcaster via a broadcasting system and an analog FM or digital radio embedded in the user device. The related mCards may, in turn, be streamed to the user or mobile device either over a wireless data connection or cellular network (e.g., General Packet Radio Service (GPRS)), or via a digital radio broadcasting (e.g., DAB, DRM, etc.). Likewise, in Mobile TV systems, the user may receive the audio and video streams (i.e., the television content) and data stream (e.g., ESG/EPG) from the television service provider, television station and/or broadcaster via an IP datacasting (IPDC)/DVB-H receiver embedded in the mobile device. The mCards may be streamed to the user device over either the IPDC/DVB-H broadcasting or a wireless data connection, such as GPRS. FIG. 2 illustrates these exemplary manners in which the mobile device may receive the media objects and/or mCards in accordance with exemplary embodiments of the present invention.

Method of Sharing Media-Related Information:

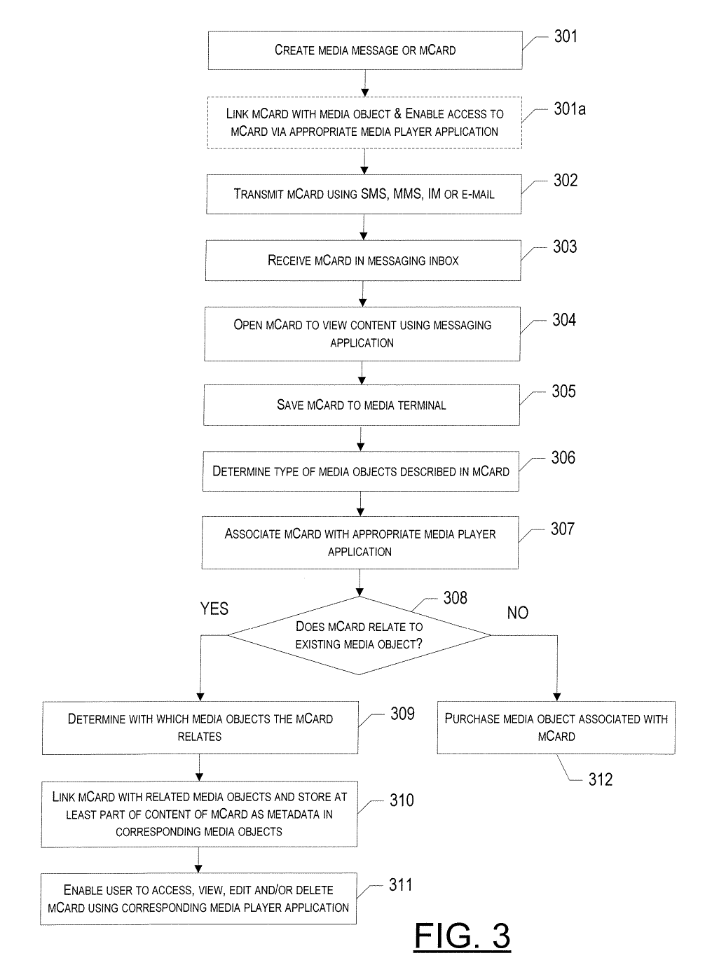

Reference is now made to FIG. 3, which illustrates the steps which may be taken in order to share media-related information in accordance with exemplary embodiments of the present invention. As shown, the process begins at Step 301, when the media message or mCard is created. As discussed above, an mCard is a digital representation of the metadata associated with one or more media objects or files. In order to create the mCard, the metadata is extracted from the media file and formatted into a data packet that can be transmitted via SMS, MMS, IM, e-mail, or the like. In addition, other information that may not already be included in the metadata of the media file may be added to the mCard. This may include, for example, a link to where the media object can be purchased (e.g., the URL address of an online retail service or shop), a 10-15 second audio/video clip of the media object itself, a link to a weblog relating to the corresponding artist or album, and/or information regarding tour dates and ticketing information. Personalized data including, for example, comments, various ratings, or a personalized note to whomever the mCard may ultimately be sent, may likewise be added to the mCard. In one exemplary embodiment, the personalized data of the mCard is capable of being edited throughout the life of the mCard by whomever is associated with the mobile device on which the mCard resides.

As will be recognized by those of ordinary skill in the art, any number of pieces of information relating to a particular media object may be included in the corresponding mCard without departing from the spirit and scope of exemplary embodiments of the present invention. Accordingly, the media-related information described above is given for exemplary purposes only and should not be taken as limiting the scope of exemplary embodiments of the present invention.

In one exemplary embodiment, mCards may be created by the party responsible for creating the actual media object. For example, an individual may create an mCard for a photograph he or she has taken and stored on his or her media terminal. Alternatively, the mCard may be created by a service provider responsible for offering the media object for sale. The service provider may then include the mCard with the media objects sold, as well as separately distribute the mCards as part of a promotion or advertisement. In one exemplary embodiment, where possible, metadata included in existing ID3 or MPEG tags associated with the media objects may be reused in creating the mCard. In particular, in one exemplary embodiment, a tool may be used that would enable the existing tags that have been created using, for example, an TDv3 tagging system, to be converted into the corresponding mCards. In this way, service providers would be able to simply convert the existing tags of their media objects into mCards and, likewise, individuals would be able to add information found in a newly created/received mCard to the metadata of an existing media object (i.e., an object that did not previously have a corresponding mCard).

Where, as discussed above, the party creating the mCard is the party responsible for actually creating the media object itself, once the mCard has been created, it may be linked to the media object and subsequently accessed via a corresponding media rendering application, mCard editor and/or archive application, or set of computer programming instructions responsible for rendering various media objects (i.e., converting any coded content to the required format for displaying the media objects) and for displaying metadata associated with those objects (Step 301a) (see below for discussion of how the corresponding media rendering application is selected or determined). To illustrate, assuming, for example, the media object is a photograph, while viewing the photograph using a gallery, or similar, application operating on the media terminal (i.e., the media rendering application responsible for rendering photographs), a user may have the option of viewing photograph information. By selecting this option, the user may cause the gallery application to access and enable the user to view and/or edit the corresponding mCard. By automatically connecting the mCard with the media object, as well as the appropriate media rendering application, exemplary embodiments of the present invention eliminate the need for a user to separately store and keep track of the various mCards created and/or received. In contrast, respective media rendering applications will be aware of and have access to the mCards upon request by the user during operation of that media rendering application.

According to one exemplary embodiment, mCards created and stored in either of the above manners (i.e., by the media object creator or by the service provider) are capable of subsequently being transmitted to various media terminals via a messaging application, such as SMS, MMS, IM or e-mail (Step 302). In other words, SMS, MMS, IM, e-mail, or the like may be used as bearers for transmitting the mCards using any number of wireless or wired technologies (e.g., wireless local area network (WLAN), Bluetooth, Ultra Wideband (UWB), Infrared Data Association (IrDA), to name a few).

As discussed above, the mCard may be sent from one person to another, downloaded from a website by the individual associated with the media terminal, sent as part of a promotion or subscription by a party from whom the media object can be purchased, or the like. In addition, the mCard may be transmitted either separately or in conjunction with the media object itself.

In one exemplary embodiment, in order for an individual to receive one or more media messages or mCards from a service provider (or media service provider) as part of a subscription, the individual may first be required to transmit a request to the media service provider for the provisioning of the corresponding media service (e.g., an online music, audio, video, image or game provisioning service). Alternatively, when an individual (i.e., user device) accesses the media service provider, one or more media messages or mCards may be transmitted automatically. In yet another alternative, where the mCard was sent by another person, the sending party may have been given the option of transmitting the mCard upon accessing the mCard using his or her media terminal. To illustrate, continuing with the example discussed above where a user is provided access to an mCard upon selecting the option of viewing photograph information relating to a particular photograph being viewed using a gallery, or similar, application, once the user has accessed the mCard, he or she may be given the further option of (among other things) transmitting the mCard to another party or device. Upon selecting this option, the user may then specify to whom the mCard should be sent.

Returning to FIG. 3, in Step 303, the individual to whom the mCard was transmitted, receives the mCard in his or her messaging inbox, and is subsequently capable of opening the mCard and viewing its contents (i.e., the media-related information) in a manner similar to other SMS, MMS, IM, or e-mail messages, or the like (Step 304). In particular, in one exemplary embodiment, the recipient's media terminal may be capable of recognizing the format of the message as, for example, an mCard, a vCard (i.e., a similar data packet used to convey contact information), an SMS, MMS or IM message, an e-mail, or the like) and processing the message accordingly. The user is, therefore, able to open the mCard and view its contents using the media terminal messaging application.

After accessing and viewing the mCard using the media terminal messaging application, the recipient may save the mCard to his or her media terminal (Step 305). In one exemplary embodiment, this may result in the media terminal first determining what type of media object(s) are associated with the mCard (i.e., determining whether the media objects comprise, for example, audio, video or image files, or the like) (Step 306), and then associating the mCard with an appropriate media rendering application based at least in part on the type determined (Step 307). For example, where the media object comprises an audio file (e.g., a song), the mCard may be associated with a music player application operating on the media terminal. Alternatively, where the media object comprises a video file (e.g., a TV show or movie clip), the mCard may be associated with a media rendering application responsible for rending video files. In yet another alternative embodiment, where the media object comprises an image file, the mCard may be associated with an image album/gallery/editor application. In general, Step 307 may involve automatically saving the mCard where it can be accessed by the appropriate media rendering application and informing the media rendering application of its existence and location. As discussed above, according to exemplary embodiments of the present invention, the user is not required to separately store and keep track of the mCards created and/or received. In contrast, the various media rendering applications will automatically be aware of and provide access to the respective mCards upon request by the user during operation of those media rendering applications.

In one exemplary embodiment, to facilitate this process, a message identifier may be associated with respective mCards, wherein in order to determine the type of media object associated with the mCard, the media terminal may review the corresponding message identifier. In addition, the message identifier may be used by the media terminal when storing the mCards in order to distinguish between stored mCards, and to identify specific mCards to the corresponding media rendering applications.

In one exemplary embodiment, the message identifier may be associated with the mCard at the time of creation (i.e., by the party creating the mCard). For example, in one exemplary embodiment, a media service provider may associate a unique message identifier with each mCard created and transmitted. The message identifier of this exemplary embodiment may, for example, include two distinct parts—a first part that uniquely identifies the media service provider and is, therefore, the same for all mCards transmitted by that media service provider, and a second part that is unique to the specific mCard, at least with respect to other mCards created and transmitted by the same media service provider. Alternatively, or in addition, the message identifier may be applied upon receipt of the mCard by the party ultimately responsible for storing the mCard. The latter message identifier may be in addition to the former, causing the mCard to potentially have two message identifiers, one for internal tracking (i.e., for cataloguing the mCards within the media terminal) and one for external tracing purposes (i.e., for enabling, for example, a service provider to keep track of the mCards sent and to enable automatic provisioning of and charging for media objects purchased, discussed below).

In one exemplary embodiment, the mCard received may be related to a media object currently stored on the media terminal (as determined in Step 308). This may be the case, for example, where an individual desires to share comments, ratings, album cover art, or the like, associated with a particular song, with a friend who already possesses that song. In this exemplary embodiment, in Step 309, it is determined with which of the stored media objects the mCard relates. In one exemplary embodiment, the party associated with the media terminal manually selects which media objects should be linked to the mCard (e.g., to which music files the image of the album cover included in the mCard should be added). In another exemplary embodiment, the mCard and media object are automatically linked by the media terminal. In particular, the media terminal of one exemplary embodiment may be capable of comparing certain information in the mCard with the metadata of various media objects stored on the media terminal in order to determine with which media object the mCard corresponds.

Once it is determined with which one or more media object(s) the mCard relates, in Step 310, the mCard received is linked to the corresponding one or more media object(s) in the media rendering/player application (e.g., to the corresponding song in the music player), and the content of the mCard is merged into the metadata associated with that media object (i.e., at least part of the content of the mCard is added to the metadata associated with the corresponding media object). In this manner the mCard can be used to complete the metadata of a particular media object, for example, by providing an image of the artist or album cover associated with a particular song. Alternatively, the mCard may be kept separate while linked to the one or more relevant media objects.

Once the mCard has been linked to the media object(s), the appropriate media rendering application has been made aware of and granted access to the mCard, and the contents of the mCard have been added to the metadata associated with that media object, a user is able to access, view, edit and delete the included information using the corresponding media rendering application (Step 311).

As discussed above, in another exemplary embodiment, the mCard may not be related to a media object currently stored on the media terminal, and instead may have been received from a service provider as part of a promotion or subscription, or from another individual. In this exemplary embodiment, the individual may further store the mCard and/or act on the mCard received.

For example, as discussed above, in one exemplary embodiment, mCards may be mass distributed (e.g., to subscribers of a particular service and/or for promotional purposes) by the music, movie or television industry. In one exemplary embodiment, the mCard may include a URL, or similar, address associated with the online retail shop from which the mobile object can be purchased. The recipient of such an mCard may be capable of, for example, browsing to the address and subsequently purchasing the media object (Step 312). In one exemplary embodiment, upon selecting the address or link included in the mCard, or by returning via an e-mail/SMS/MMS to the service provider, the media object may be automatically downloaded to the user's media terminal, and the user may be automatically billed for the purchase, without the user being required to take any further action (e.g., without the user having to find the media object and go through the purchasing process on the online retailer's web site). In this exemplary embodiment, the mCard may have a unique identifier associated therewith that is capable of being recognized by the online retail shop as being associated with the particular media object and the particular user. As such, the online retail shop is capable of merely seeing that a request has been sent based on the particular mCard having this unique identifier and automatically knowing which media object to transmit and who to bill for the purchase.

In general, in addition to being able to view, store, move, transmit and/or delete mCards from a media terminal, in one exemplary embodiment, objects stored in the mCards are further capable of being searched and applied to one or more selected media objects stored on the media terminal. For example, a user may receive an mCard associated with a particular music album, wherein the mCard includes an image of the album cover, as well as comments and ratings regarding the album as a whole. The user may search the mCards associated with the songs stored on his or her media terminal in order to find all of the songs he or she possesses that are on that particular album. Once the songs have been found, the user may cause the album cover image to be applied to each of the respective mCards of those songs.

In addition, as mentioned above, mCards store not only origin-controlled information, but also certain personalized data including, for example, personal comments, ratings, and the like. According to exemplary embodiments of the present invention, therefore, in addition to being able to view the content of various mCards, users are able to edit that content throughout the life of the mCard.

Overall System and Mobile Device:

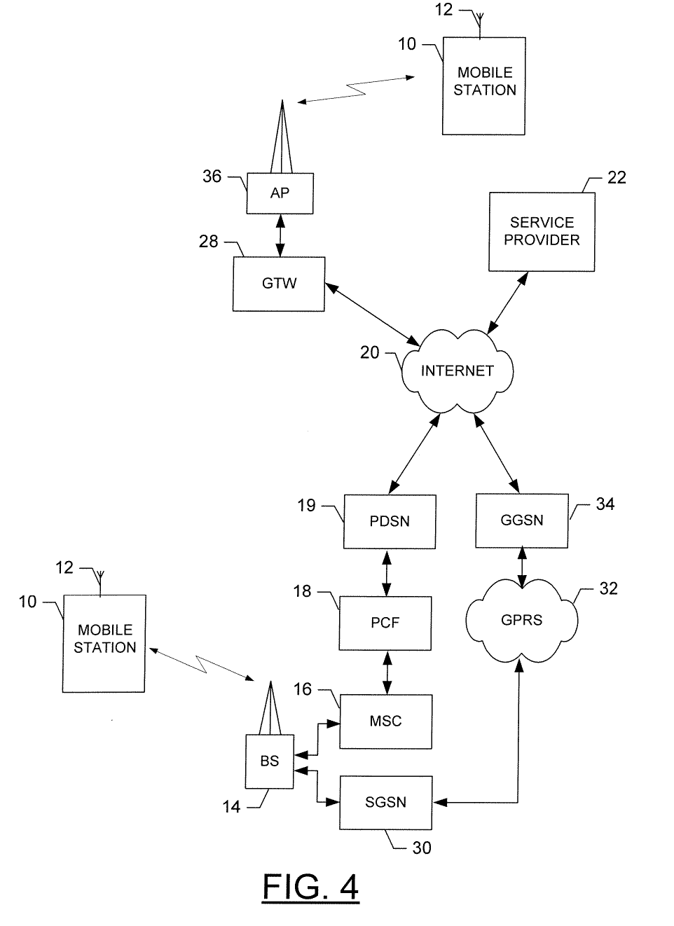

Referring to FIG. 4, an illustration of one type of system that would benefit from exemplary embodiments of the present invention is provided. As shown in FIG. 4, the system can include one or more media terminals, which, in one exemplary embodiment, may comprise mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include one or more devices associated with a Media Service Provider 22, which, as discussed above, may be capable of creating and transmitting media messages or mCards to media terminals (such as mobile stations) associated with various users, for example, as part of a promotion or subscription. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (IG), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 4) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., one or more device associated with the Media Service Provider 22) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 4, in addition to or in lieu of coupling the mobile stations 10 to one or more processing elements (e.g., one or more devices associated with the Media Service Provider 22) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

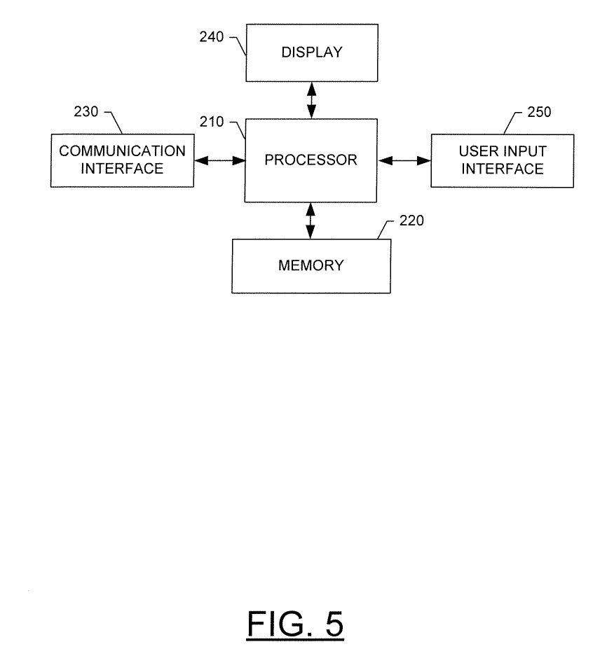

Referring now to FIG. 5, a block diagram of an entity capable of operating as a device associated with a Media Service Provider 22 is shown in accordance with one embodiment of the present invention. The entity capable of operating as a device associated with the Media Service Provider 22 includes various means for performing one or more functions in accordance with exemplary embodiments of the present invention, including those more particularly shown and described herein. In particular, the entity of exemplary embodiments may include means for creating one or more media messages or mCards comprising information relating to one or more media objects or files, and for transmitting those messages to one or more media terminals, for example, as part of a promotion or subscription. In addition, the entity may include means for receiving a purchase request from one of the media terminals for at least one of the media objects described in the mCards transmitted, and for communicating the request to a source from which the media objects can be obtained. As discussed above, in one exemplary embodiment, the mCards transmitted may include an identifier that is unique, not only to the particular media service provider, but also to that mCard and, thus, to the media object described and the media terminal to which it was sent. The device associated with the Media Service Provider 22 may, therefore, also include means for determining, based at least in part on this unique identifier, which media objects the party from whom the purchase request was received is interested in purchasing, as well as the identity of that party.

It should be understood, however, that one or more of the entities may include alternative means for performing one or more like functions, without departing from the spirit and scope of the present invention. As shown, the entity capable of operating as a device associated with a Media Service Provider 22 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

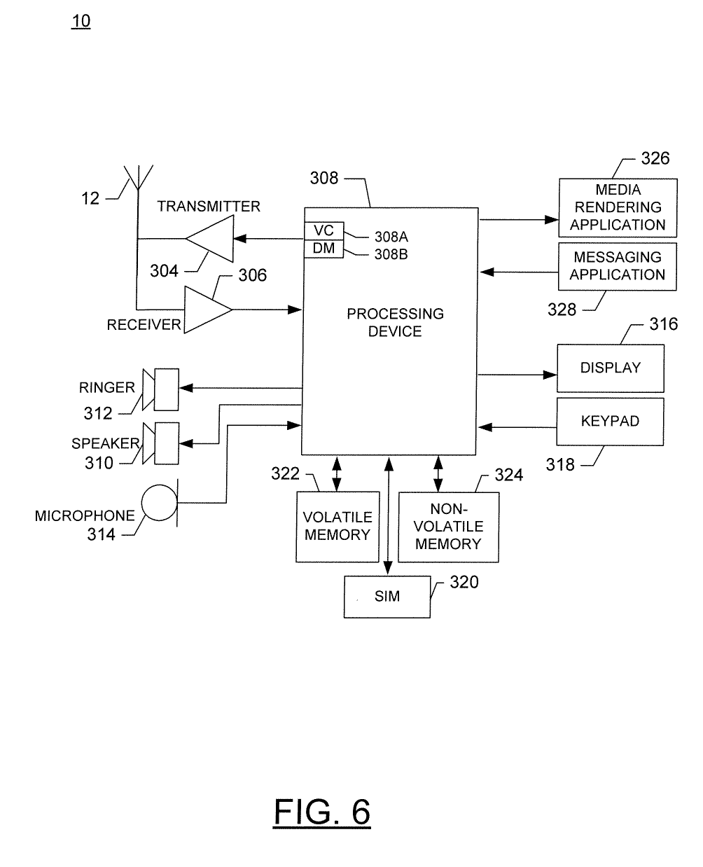

Reference is now made to FIG. 6, which illustrates one type of media terminal that would benefit from embodiments of the present invention. As shown, the media terminal may be a mobile station 10, and, in particular, a cellular telephone. It should be understood, however, that the mobile station illustrated and hereinafter described is merely illustrative of one type of media terminal that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 6, in addition to an antenna 12, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like. The mobile station may likewise be capable of receiving broadcasted data (e.g., audio, video and/or data streams broadcast in either or both a Mobile TV or Visual Radio system, as discussed above) via the antenna 12 and/or receiver 306, which may comprise a IPDC/DVB-H receiver or an analog FM or digital radio.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code that defines one or more media rendering applications 326 configured to render one or more media objects and to display metadata associated with respective media objects. The computer program code may further define one or more messaging applications 328 configured to receive media messages or mCards including information relating to one or more media objects, to determine a type associated with the media objects, and to associate the media message or mCard with one of the media rendering applications based at least in part on the type.

The media terminal, method, apparatus, computer program product, media service provider, data packet and system of exemplary embodiments of the present invention are primarily described in conjunction with mobile communications applications. It should be understood, however, that the media terminal, method, apparatus, computer program product, media service provider, data packet and system of embodiments of the present invention can be utilized in conjunction with a variety of other applications, both in the mobile communications industries and outside of the mobile communications industries. For example, the media terminal, method, apparatus, computer program product, media service provider, data packet and system of exemplary embodiments of the present invention can be utilized in conjunction with wireline and/or wireless network (e.g., Internet) applications.

### CONCLUSION

As described above and as will be appreciated by one skilled in the art, embodiments of the present invention may be configured as a media terminal, method, apparatus, media service provider, data packet and system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A media terminal capable of receiving media-related information, said terminal comprising:
one or more media rendering applications configured to render one or more media objects and to display metadata associated with respective media objects rendered; and
a messaging application configured to receive a message comprising information relating to one or more media objects, said messaging application further configured to determine a type associated with the media objects and to associate the message with one of the media rendering applications based at least in part on the type determined,
wherein the media rendering application with which the message is associated is further configured to store at least part of the information of the message as metadata of the one or more media objects with which the information relates.

2. The terminal of claim 1, wherein a message identifier is associated with the message, such that determining a type associated with the media object comprises reviewing the message identifier to determine the type.

3. The terminal of claim 1, wherein the type associated with the one or more media objects comprises at least one of an audio file, a video file, an image file, a text file, a graphic presentation, a web page or a software application.

4. The terminal of claim 1, wherein the media rendering application with which the message is associated is further configured to determine the one or more media objects with which the message relates.

5. The terminal of claim 4, wherein determining the one or more media objects with which the message relates comprises comparing the information of the message with metadata associated with a plurality of media objects.

6. The terminal of claim 1, wherein the media rendering application with which the message is associated is further configured to enable a user associated with the media terminal to edit the metadata associated with respective media objects.

7. The terminal of claim 1, wherein the message comprises at least one of an e-mail, a Short Message Server (SMS) message, a Multimedia Messaging Service (MMS) message or an instant message (IM).

8. The terminal of claim 1, wherein the information of the message comprises metadata.

9. The terminal of claim 1, wherein the terminal comprises some combination of a music player, a video player, an image player, a game device, a TV receiver, an FM/AM radio receiver a digital camera and a digital camcorder.

10. A method of sharing media-related information, said method comprising:
receiving a message comprising information relating to one or more media objects;
determining a type associated with the one or more media objects;
associating the message with a media rendering application based at least in part on the type determined, such that the information of the message is capable of being accessed using the media rendering application with which the message is associated; and
storing at least part of the information of the message as metadata of the one or more media objects with which the information relates.

11. The method of claim 10 further comprising:
displaying the metadata associated with respective media objects.

12. The method of claim 10, wherein a message identifier is associated with the message, and wherein said method further comprises:
reviewing the message identifier associated with the message in order to determine the type associated with the one or more media objects.

13. The method of claim 10, wherein the type associated with the one or more media objects comprises at least one of an audio file, a video file, an image file, a text file, a graphic presentation, a web page or a software application.

14. The method of claim 10 further comprising:
determining the one or more media objects with which the message relates.

15. The method of claim 10 further comprising:
enabling a user associated with the media terminal to edit the metadata associated with respective media objects.

16. The method of claim 10, wherein receiving a message comprises receiving at least one of an e-mail, a Short Message Service (SMS) message, a Multimedia Messaging Service (MMS) message, or an instant message (IM).

17. A computer program product comprising a computer-readable storage medium having computer-readable program code portions stored therein, the computer-readable program code portions configured to perform the steps of claim 10.

18. An apparatus configured to receive media-related information, said apparatus comprising:
a means for receiving a message comprising information relating to one or more media objects;
a means for determining a type associated with the one or more media objects;
a means for associating the message with a media rendering application based at least in part on the type determined, such that the information of the message is capable of being accessed using the media rendering application with which the message is associated; and
a means for storing at least part of the information of the message as metadata of the one or more media objects with which the information relates.

19. The apparatus of claim 18 further comprising:
a means for displaying the metadata associated with respective media objects.

20. The apparatus of claim 18, wherein a message identifier is associated with the message, and wherein said apparatus further comprises:
a means for reviewing the message identifier associated with the message in order to determine the type associated with the one or more media objects.

21. The apparatus of claim 18 further comprising:
a means for determining the one or more media objects with which the message relates.

22. The apparatus of claim 18, wherein receiving a message comprises receiving at least one of an e-mail, a Short Message Service (SMS) message, a Multimedia Messaging Service (MMS) message, or an instant message (IM).

23. A media service provider comprising:
a means for creating one or more media messages comprising information relating to one or more media objects;
a means for receiving a request for provisioning of a media service;
a means for transmitting the one or more media messages in response to receiving the request;
a means for receiving a purchase request for at least one of the one or more media objects; and
a means for communicating the purchase request to a source from which the media objects can be purchased.

24. The service provider of claim 23, wherein the one or more media messages comprise a link to an online retail source from which the media objects can be accessed.

25. The service provider of claim 23, wherein the media service comprises at least one of an online music, audio, video, image, or game provisioning service.

26. The service provider of claim 23, wherein the information relating to the one or more media objects comprises metadata.

27. The service provider of claim 23 further comprising:
a means for associating a unique identifier with respective media messages;

28. The service provider of claim 27, wherein the purchase request received is linked to one of the media messages transmitted, and wherein the service provider further comprises:
a means for determining, based at least in part on the unique identifier associated with the media message linked to the purchase request, the one or more media objects to be purchased and an identity associated with a party from whom the purchase request was received; and
a means for billing the party for the purchase.

29. A method of providing a media service, said method comprising:
creating one or more media messages comprising information relating to one or more media objects;
receiving a request for provisioning of a media service;
transmitting the one or more media messages in response to receiving the request;
receiving a purchase request for at least one of the one or more media objects; and
communicating the purchase request to a source from which the media objects can be purchased.

30. The method of claim 29, wherein the one or more media messages comprise a link to an online retail source from which the media objects can be accessed.

31. The method of claim 29, wherein the media service comprises at least one of an online music, audio, video, image, or game provisioning service.

32. The method of claim 29, wherein the information relating to the one or more media objects comprises metadata.

33. The method of claim 29 further comprising:
associating a unique identifier with respective media messages;

34. The method of claim 33, wherein the purchase request received is linked to one of the media messages transmitted, and wherein the method further comprises:
determining, based at least in part on the unique identifier associated with the media message linked to the purchase request, the one or more media objects to be purchased and an identity associated with a party from whom the purchase request was received; and
billing the party for the purchase.

35. A computer program product comprising a computer-readable storage medium having computer-readable program code portions stored therein, the computer-readable program code portions configured to perform the steps of claim 29.

36. An apparatus configured to provide a media service, said apparatus comprising:
a processor; and
a memory in communication with the processor, said memory storing an application executable by the processor, wherein the application is configured, upon execution, to:
create one or more media messages comprising information relating to one or more media objects;
receive a request for provisioning of a media service;
transmit the one or more media messages in response to receiving the request;
receive a purchase request for at least one of the one or more media objects; and
communicate the purchase request to a source from which the media objects can be purchased.

37. The apparatus of claim 36, wherein the one or more media messages comprise a link to an online retail source from which the media objects can be accessed.

38. The apparatus of claim 36, wherein the media service comprises at least one of an online music, audio, video, image, or game provisioning service.

39. The apparatus of claim 36, wherein the information relating to the one or more media objects comprises metadata.

40. The apparatus of claim 36, wherein the application is further configured, upon execution, to:
associate a unique identifier with respective media messages;

41. The apparatus of claim 40, wherein the purchase request received is linked to one of the media messages transmitted, and wherein the application is further configured, upon execution, to:
determine, based at least in part on the unique identifier associated with the media message linked to the purchase request, the one or more media objects to be purchased and an identity associated with a party from whom the purchase request was received; and
bill the party for the purchase.

42. A data packet for transferring media-related information between one or more devices, said data packet comprising:
a first type of data comprising origin-controlled metadata associated with one or more media objects;
a second type of data comprising personalized metadata associated with the one or more media objects;
a message type metadata; and
user identification metadata.

43. The data packet of claim 42, wherein the origin-controlled metadata comprises metadata that is not capable of being altered.

44. The data packet of claim 42, wherein the personalized metadata comprises metadata that is capable of being altered.

45. The data packet of claim 42, wherein the message type metadata comprises metadata describing a type associated with the one or more media objects, wherein the type is selected from the group consisting of an audio file, a video file, an image file, a graphic presentation, a web page, and a software application.

46. The data packet of claim 42, wherein the user identification metadata comprises metadata identifying at least one of a user or a user device.

47. A system for sharing media-related information, said system comprising:
a device associated with a media service provider, said device configured to create one or more media messages comprising information relating to a respective one or more media objects and to transmit the media messages;
a media terminal in communication with the device and configured to receive at least one of the one or more media messages, said media terminal further configured to determine a type associated with the one or more media objects of the media message received and to associate the media message with a media rendering application stored on the media terminal based at least in part on the type determined,
wherein the media rendering application with which the message is associated is configured to store at least part of the information as metadata of the one or more media objects, and wherein the information of the message is capable of being subsequently accessed using the media rendering application.

48. The system of claim 47, wherein the media messages comprise metadata associated with the respective one or more media objects.

49. The system of claim 48, wherein the metadata comprises origin-controlled metadata associated with the respective one or more media objects, said origin-controlled metadata incapable of being altered.

50. The system of claim 49, wherein the metadata further comprises personalized metadata associated with the respective one or more media objects, said personalized metadata capable of being altered.

51. The system of claim 47, wherein the device is further configured to receive a request for provisioning of a media service, and wherein the device transmits the media messages in response to receiving the request.

52. The system of claim 47, wherein a message identifier is associated with respective media messages, such that the media terminal is configured to determine a type associated with the one or more media objects of the media message received based at least in part on the message identifier associated with the received message.

53. The system of claim 47, wherein the message comprises at least one of an e-mail, a Short Message Service (SMS) message, Multimedia Messaging Service (MMS) message, or an instant message (IM).
